(19) United States
(12) Patent Application Publication
(10) Pub. No.: US 2006/0046137 A1
(43) Pub. Date: Mar. 2, 2006

(54) Battery

(75) Inventor: Yasunobu Kodama, Sumoto-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/214,033

(22) Filed: Aug. 30, 2005

(30) Foreign Application Priority Data
Aug. 31, 2004 (JP) 2004-252631

(51) Int. Cl. H01M 2/18; H01M 2/26; H01M 2/08

(52) U.S. Cl. 429/129; 429/246; 429/161; 429/211; 429/181; 429/184

(57) ABSTRACT

Provided is a battery such as a laminated battery, which has a favorable battery performance by being endowed with heat resistance. In the laminated battery 1, tab resins 103, 104, securing tape 105, protection tape 150, and protection tape 160 are made of cast polyolefin having heat resistance.

### BACKGROUND OF THE INVENTION

(1) Field of the Invention

The present invention relates to an internal structure of a battery. Particularly, the present invention relates to a technology for improving heat resistance of a laminated battery such as a lithium polymer battery.

(2) Related Art

Recent years have seen widespread use of small electronic devices such as portable telephones, pocket personal computers, portable audio devices, digital cameras, and personal digital assistances (PDA). In accordance with this trend, there is a rapidly increased demand for thin and light batteries that allow a large capacity. In particular, laminated batteries, each equipped with a lithium polymer electrolyte and a laminate casing, are already used for such small electronic devices, because of being flexible, extremely thin, light, and of allowing a large capacity at the same time.

A power generating element of a conventional laminated battery is generated in the following way. First, a positive electrode plate and a negative electrode plate, both having a band shape, are wound with a separator sandwiched therebetween, and then are flattened. Then thus obtained winding body is impregnated with an electrolyte. To the winding body, cores of the positive/negative electrode plates are respectively provided with a corresponding tab (current collecting terminal), so that the tabs, exposed outside, function as a positive terminal and a negative terminal respectively. With the tabs being exposed outside, the circumference of the power generating element is covered with a laminate casing.

The laminate casing, covering the power generating element, is sealed by thermo-compression bonding, especially in the vicinity of the tabs to make sure that the electrode body and the electrolyte will not come out.

Inside the laminated battery, tape made of orientated polyolefin such as orientated polypropylene (OPP) is used in several places.

For example, Japanese Laid-open patent application No. H11-312514 discloses that the tabs are protected by the above-mentioned tape, at surface positions thereof connecting to the electrode plates. This is for preventing the tabs from breaking the electrode plates in the forming process of the winding body, and for preventing short. In addition to this, the tabs are inserted in corresponding tape formed in tubular form, for strengthening seal by the thermo-compression bonding. Furthermore, securing tape made of polypropylene (pp) is applied to the end of the winding of the winding body, and to the upper end and the lower end of the winding body, for protection.

However, the tape made of orientated polyolefin has relatively low heat resistance, and so can have a detrimental effect on the battery performance.

For example, a laminated battery has a structure of sealing the battery by subjecting its laminate casing to thermo-compression bonding. In the thermo-compression bonding, however, such tape can deteriorate (e.g. softens or shrinks). Such adverse effect of heat is also expected to happen when the battery undergoes overheating due to battery anomalies.

Such deterioration of tape is desired to be prevented because if the tape is used as the protection tape for a tab, it can cause the tab to be exposed to come into contact with a different electrode plate thereby causing short.

As stated above, the current laminated batteries have a problem to be solved. This particular problem is common to any types of battery that uses therein the same kind of tape as stated above.

### SUMMARY OF THE INVENTION

The present invention, having been conceived in light of the aforementioned problem, has an object of providing a battery such as a laminated battery, which is prevented from deterioration of tape used inside the battery, and so has favorable battery performances.

So as to solve the above-mentioned problem, the present invention provides a battery having: a casing; an electrode body in which a positive electrode plate and a negative electrode plate are stacked with a separator sandwiched therebetween; and tabs respectively connected to the positive electrode plate and the negative electrode plate, the casing being hermetically sealed with the electrode body stored therein and with part of each of the tabs exposed outside the casing, where inside the casing, a cast polyolefin is attached to at least one of the following positions: i) inside the electrode body, ii) on the electrode body, and iii) on the tabs.

According to the above-stated battery construction, a cast polyolefin excellent in heat resistance is used inside the casing. Therefore the battery according to the present invention has improved battery performance compared to a conventional structure that uses orientated polyolefin.

For example, when the battery undergoes overheating due to battery anomalies and the like, the cast polyolefin is hardly deformed or shrink due to heat.

Therefore, if such a cast polyolefin is used as a material of tape inside the battery, the tape would not shrink due to heat. This prevents exposure of the power generating element and the connection part between the tabs and the corresponding electrode plates, which are covered with the tape. This helps effectively prevent occurrence of short, and so helps offer stable battery performances.

When the present invention is applied to a laminated battery, it also produces an advantageous effect against heat influence in the heating processing (laminate processing) by which the laminate casing is sealed, in addition to the above-stated effect. For example, the vicinity of the tabs near the sealing parts tends to be exposed to high heat in the heating processing. However, by making the vicinity of the tabs by cast polyolefin as in the present invention, the sealing is performed favorably.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the drawings:

FIG. 1 is an overall view of a lithium polymer battery (laminated battery) according to a first embodiment of the present invention;

FIGS. 2A and 2B are diagrams showing the battery structures in the vicinity of the positive/negative electrode plates, where FIG. 2A shows the battery structures in the vicinity of the positive electrode plate, and FIG. 2B shows the battery structures in the vicinity of the negative electrode plate; and

FIG. 3 is a schematic diagram showing a process of sealing the laminated battery.

### DESCRIPTION OF THE PREFERRED EMBODIMENTS

### 1-1. Structure of Polymer Battery

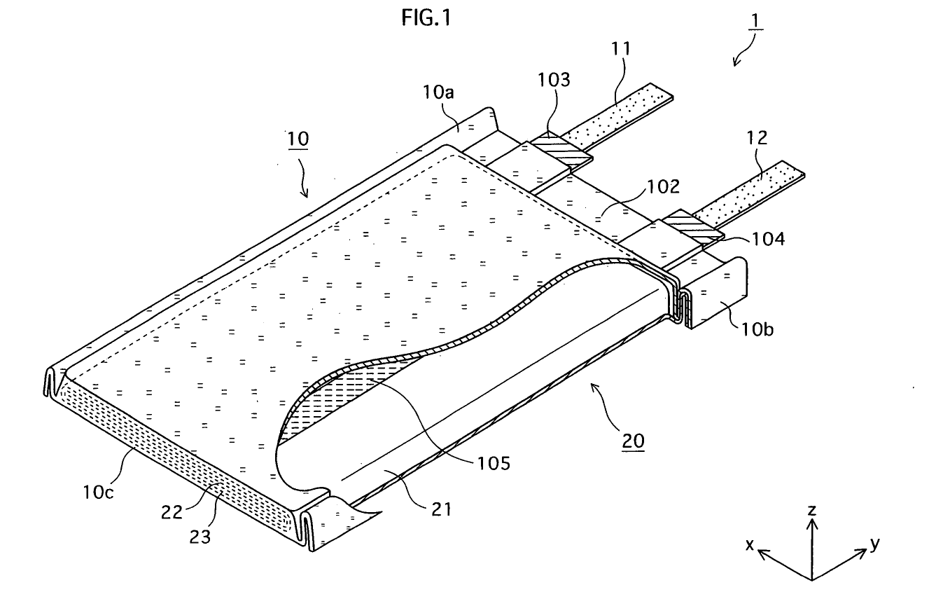

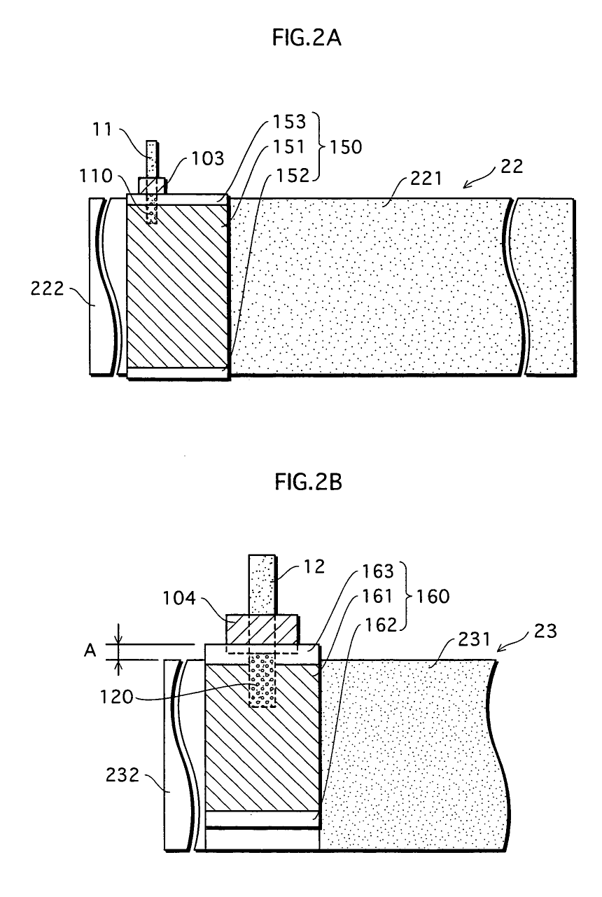

FIG. 1 shows a structure of a square lithium polymer battery 1 according to a first embodiment, being one example of a battery according to the present invention. Hereinafter, the square lithium polymer battery 1 is simply referred to as “laminated battery 1”. FIGS. 2A and 2B are partly-enlarged diagrams showing structures of the laminated battery 1 in the vicinity of the positive/negative electrode plates. Specifically, FIG. 2A shows a structure of the laminated battery 1 in the vicinity of the positive electrode plate, and FIG. 2B shows a structure of the laminated battery 1 in the vicinity of the negative electrode plate.

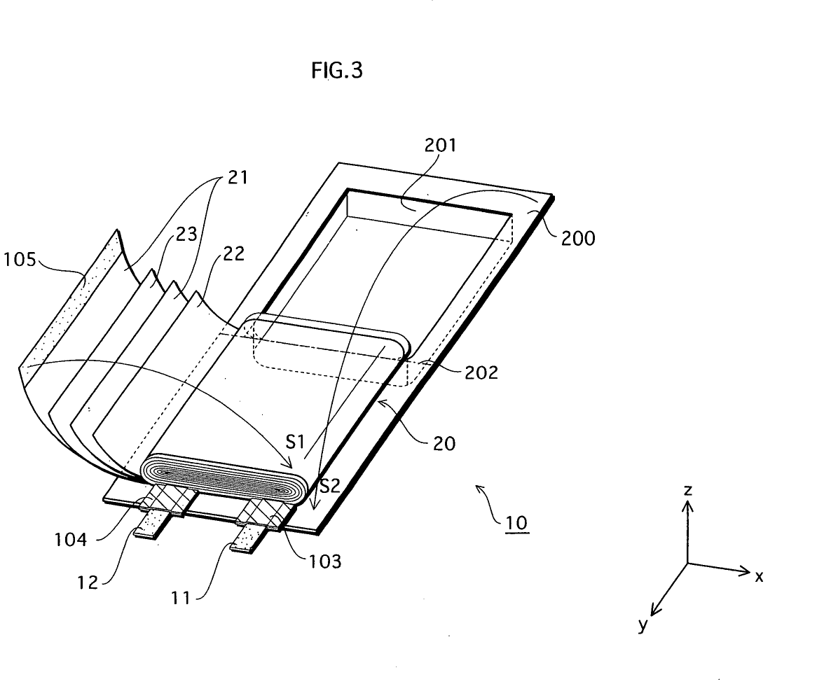

FIG. 3 is a schematic diagram showing a process of sealing the laminated battery 1.

As FIG. 1 shows, the laminated battery 1 has the following structure. A laminate casing 10, formed as a thin rectangular solid, stores therein an electrode body 20. From the electrode body 20, tabs 11 and 12 extend to outside the laminate casing 10, where the tabs 11 and 12 respectively correspond to a positive electrode and a negative electrode. A top sealing part 102, side sealing parts 10a and 10b, and a bottom part 10c, which constitute each side of the laminate casing 10, are formed such that the inside of the laminate casing 10 is hermetically sealed. The dimensions of the battery are 6 cm×3.5 cm×3.6 mm (length, width, and thickness) for example.

The electrode body 20 is made of a winding body. The winding body is made by winding a positive electrode plate 22 and a negative electrode plate 23, both having a band shape, with a separator 21 sandwiched therebetween, to form a spiral body. The spiral body is then flattened to produce a thin rectangular solid shape.

Note that the “rectangular solid shape” of the electrode body is not a real rectangular solid shape in a strict sense, because the sides of the electrode body 20 are curved. In the present invention, however, such a substantially rectangular solid shape is referred to as “rectangular solid shape”.

It is alternatively possible to structure the winding body 20 by simply stacking a positive electrode plate and a negative electrode plate both in a rectangular shape, with a separator sandwiched therebetween.

The separator 21 is made of porous polyethylene with a thickness of 0.03 mm, for example.

The positive electrode plate 22 is, for example, made by applying lithium cobalt oxide (LiCoO₂), as an active material, to a core made of aluminum foil having a band shape.

The negative electrode plate 23 is, for example, made by applying graphite particles to a core made of copper foil having a band shape.

Note that the electrode body 20 is designed so that the width becomes larger in the order of the positive electrode plate 22, the negative electrode plate 23, and the separator 21. This is for restricting occurrence of dendrite, because by allocating a larger area for the negative electrode plate 23 than for the positive electrode plate 22, the Li ion from the positive electrode plate 22 is sufficiently absorbed in the negative electrode plate 23 during charging of the laminated battery 1. In the electrode body 20, securing tape 105 is attached to and secures the outermost portion of the separator 21.

The peripheral structure is substantially the same for the negative electrode plate 23 and the positive electrode plate 22.

As shown in FIG. 2A for example, a core is exposed outside at the end of the positive electrode plate 22 that is positioned in the downstream side of the winding direction of the positive electrode plate 22. This part of the positive electrode plate 22 whose core is exposed outside forms a reader unit 222. In the reader unit 222, a tab 11, having a band shape, is connected at a connection part 110 by such a method as resistance welding, in such a manner that a predetermined length of the tab 11 will extend to outside. The tab 11 functions as a current collecting terminal and is made of aluminum, nickel, copper, and the like. Furthermore, protection tape 150 is attached to cover the connection part 110 as well as an area of the reader unit 222 in the vicinity of the connection part 110, to prevent the edge of the tab 11 from protruding through the separator 21 to cause short with the negative electrode plate 23. A surface of the protection tape 150 has an adhesive provision area 151 via which the protection tape 150 is attached. The size and form of the protection tape 150 is not particularly limited, but the protection tape 150 should at least cover the connection part 110 favorably. In the stated example of FIG. 2A, the protection tape 150 is designed slightly larger than the positive electrode plate 22 in the widthwise direction of the positive electrode plate 22. In other words, the protection tape 150, when it is attached, lies off the positive electrode plate 22 in the widthwise direction of the positive electrode plate 22. This is useful for assuredly preventing short between cores respectively for the positive electrode plate 22 and the negative electrode plate 23.

As shown in FIG. 2B, the negative electrode plate 23 is structured in the similar way. Specifically, a core is exposed outside at the end of the negative electrode plate 23 that is positioned in the downstream side of the winding direction of the negative electrode plate 23. This part of the negative electrode plate 23 whose core is exposed outside forms a reader unit 232. In the reader unit 232, a tab 12 identical to the tab 11, is connected at a connection part 120 by such a method as resistance welding, in such a manner that a predetermined length of the tab 12 will extend to outside. Furthermore, protection tape 160 is attached to cover the connection part 120 as well as an area of the reader unit 232 in the vicinity of the connection part 120, to prevent the edge of the tab 12 from protruding through the separator 21 to cause short with the positive electrode side. A surface of the protection tape 160 has an adhesive provision area 161 via which the protection tape 160 is attached. The size and form of the protection tape 160 is not particularly limited, but the protection tape 160 should at least cover the connection part 120 favorably. In the stated example of FIG. 2B, the protection tape 160 is designed slightly larger than the negative electrode plate 23 in the widthwise direction of the negative electrode plate 23. In other words, the protection tape 160, when it is attached, lies off the negative electrode plate 23 in the widthwise direction of the negative electrode plate 23. This is useful for assuredly preventing short between cores respectively for the positive electrode plate 22 and the negative electrode plate 23.

Here, tape exposure parts 152, 153, 162, and 163 are provided for the protection tape 150 and the protection tape 160, at edges where there are provided with corresponding tabs. The tape exposure parts 152, 153, 162, and 163 are provided to prevent the adhesives from attaching to other members within the laminate casing 10 if the protection tape 160 (or 150) is deviated from an intended position when it is attached (e.g. a region shown by “A” in FIG. 2B). In particular, 153 and 163 are for preventing adhesives from being leaked under the top sealing part 102 of the laminate casing 10, which would melt at the time of thermo-compression bonding to deteriorate sealing.

Further for the tabs 11 and 12, tab resins 103 and 104 are respectively provided at positions corresponding to the top sealing part 102 of the laminate casing 10. “tab resin” is also referred to as “thermo-compression bonding film” or “current collecting terminal film”. The tab resins 103 and 104 are prepared in the following way for example. First, a film, which has a band shape and a width of about 1 cm, is formed into a loop, and the loop is deformed from its side into a rectangular form. Thus obtained loop is inserted to the tab 11 (12). Ideally, the tab resins 103 and 104 are provided adjacent to the ends of the protection tape 150 and the protection tape 160, respectively.

It is also possible to provide extra protection tape at ends of the electrode body 20 in the upper and lower directions, for the purpose of maintaining the shape.

In addition, in FIG. 1, the width is different for the tab 11 and the tab 12, for facilitating visual recognition, and for preventing the polarities from being mistaken. Specifically in the example of FIG. 1, the tab 11 has a width of 3 mm, and the tab 12 has a width of 5 mm. Needless to say, however, the tab 11 and the tab 12 may have the same width.

The electrode body 20 is impregnated with a polymer electrolyte in gel form as a nonaqueous electrolytic solution.

The polymer electrolyte is prepared in the following way, for example. First, polyethylene glycol diacrylate is mixed with an EC/DEC mixture (mass ratio of 30:70) in proportions of 1:10. Having been added 1 mol/l of LiPF₆ thereto, the resulting mixture undergoes thermal polymerization so as to be rendered into gel form.

For example, the laminate casing 10 is made of a laminate film (a thickness of about 100 μm) having a three-layer structure made of polypropylene/aluminum/nylon, and has a three-sides sealing structure (a cup-type laminate), which is sealed at the three sides at the polypropylene layer by thermo-compression bonding.

The following methods may be employed to seal the laminate casing 10.

As seen in the schematic diagram showing a sealing process (FIG. 3), firstly, a laminate film material 200 is cut in a band form, and a concave 201 is formed thereto.

Then, the electrode body 20, having been wound and secured at the end (Si), is placed onto the laminate film material 200. After checking to see whether the electrode body 20 is placed in a right position so as to be stored in the concave 201, the laminate film material 200 is folded into half at a center 202 of the lengthwise direction of the laminate film material 200 (S2). Hereinafter, the laminate film material 200 is occasionally referred to as “200”.

Next, the side sealing parts 10a and 10b are formed by subjecting both the ends A of 200 in the widthwise direction to thermo-compression bonding. Finally, thermo-compression bonding is performed to the circumferential area of the laminate casing 10 so as to traverse the tabs 11 and 12, thereby completing the top sealing part 102.

Note that as a result of this processing, the electrode body 20 should be stored in the laminate casing 10, in the state that about 1.6 cm of the end of the tab 11 (12) is exposed outside.

Needless to say, there are other sealing methods than the one stated above. In one of such methods, for example, a cup-type laminate casing 10 is created first. Then an electrode body 20 is stored in the created laminate casing 10. Finally, a top sealing part 102 is formed by thermo-compression bonding.

To such a laminate casing 10, tabs 11 and 12 respectively provided with tab resins 103 and 104 are placed. Then the thermo-compression bonding is performed so that the laminate casing 10 traverses the tab resins 103 and 104, thereby forming a top sealing part 102. As a result of the thermo-compression bonding, the tab resins 103 and 104 present a welding characteristic with respect to the both surfaces of the tabs 11 and 12, and to the opposing inner surfaces of the laminate casing 10. This helps maintain the sealing of the top sealing part 102.

The laminated battery 1 of the present invention is characterized by adopting, as a material for each of the tab resins 103 and 104, the securing tape 105, and the protection tape 150 and the protection tape 160, cast tape such as cast polyolefin (e.g. cast polypropylene (CPP)), which exhibits higher resistance against heat than an orientated polypropylene (OPP) which is conventionally used.

The laminated battery 1, using the above-stated material, can prevent deterioration of the tab resins 103 and 104, the securing tape 105, the protection tape 150, and the protection tape 160, even if the heat generated in subjecting the laminate casing 10 to thermo-compression bonding reaches as far as the securing tape 105, the protection tape 150, and the protection tape 160. This helps maintain favorable battery performances.

The following describes the effect in more detail.

### 1-2. Effect of the First Embodiment

In the laminated battery 1 according to the first embodiment, heat-resistant cast polyolefin is used as a material of the tab resins 103 and 104, the securing tape 105, the protection tape 150, and the protection tape 160. Therefore, the tape used in the laminated battery 1 has dramatically improved heat resistance compared to a conventional structure that uses orientated polypropylene or the like as a material for the tape.

The heat resistant characteristic of the cast polyolefin is such that it hardly shrinks under high heat. As a result, it is possible to prevent unnecessary shrink of the tape used in the laminated battery 1, under a condition where the laminated battery 1 undergoes a certain degree of heat or above (e.g. in laminate thermo-compression bonding in the production process, or when the battery undergoes abnormally high heat due to some failure while being driven). Accordingly, the cast polyolefin prevents the components of the battery from being exposed outside the covering tape, thereby facilitating stable battery performances. For example, the mentioned CPP allows the heat resistance up to about 120 degrees centigrade.

For example, if a cast polyolefin is used as a material of the protection tape 150 and the protection tape 160, neither the protection tape 150 nor the protection tape 160 would shrink due to heat, and so the surfaces of the tabs 11 and 12, which are covered with the protection tape 150 and the protection tape 160, will not be exposed inside the electrode body 20. Therefore, the tabs 11 and 12 are prevented from contacting the opposing separator 21, the positive electrode plate 22, and the negative electrode plate 23, thereby effectively preventing short therebetween. In addition, because the edges of the tabs 11 and 12 are protected, an effect of effectively preventing the separator from breakage will be produced.

Furthermore, the vicinity of tabs near the sealing parts tends to be exposed to high heat. However, by making the tab resins 103 and 104 by cast polyolefin, the resins are favorably filled in the top sealing part 102, which ensures sealing. Accordingly, favorable battery performances are realized without impairing the sealing reliability of the top sealing part 102. It is desirable to make the tab resins 103 and 104 by cast polyolefin, because the cast polyolefin favorably melts at the top sealing part 102.

Here, concrete examples of the cast polyolefin are polypropylene, denatured polypropylene, polyethylene, denatured polyethylene, polymethylpentene, and a copolymer of them.

When the securing tape 105 is made of cast polyolefin, the heat shrink thereof at the surface of the electrode body 20 is prevented even under high heat. Accordingly, an effect of favorably securing the winding end is maintained. This helps prevents the winding ends from loosening within the laminated electrode 1, thereby preventing the winding structure from being deformed.

Note that it is not necessary to use cast polyolefin to all of the tab resins 103, 104, the securing tape 105, the protection tape 150, and the protection tape 106. A certain degree of effect is expected if cast polyolefin is used for some of them. However, it is desirable to make all of these components by cast polyolefin to avoid occurrence of heat shrink, considering that the entire battery tends to undergo overheating at the time of battery anomalies.

### <Manufacturing of Embodiment Examples and Comparison Examples>

### Embodiment Example 1

As an active material for the positive electrode, a mixture, in which spinel-structure lithium manganese oxide (e.g. LiMn₂O₄), and lithium cobalt oxide (e.g. LiCoO₂) are mixed in a certain ratio, is used.

Note that, although not used in the present embodiment example, either lithium manganese oxide or lithium cobalt oxide, which is mixed with a different type of chemical element, may also be used as the active material for the positive electrode.

To this mixture as a positive-electrode active material, a carbon conductive agent and graphite are mixed in a predetermined amount. Then the resulting mixture is mixed with a fluoropolymer-based bonding agent at a predetermined ratio, thereby obtaining a positive-electrode mixture. This positive-electrode mixture is applied onto both surfaces of the aluminum foil (i.e. a core of the positive electrode), and is dried. After being dried, the aluminum foil to which the positive-electrode mixture has been applied is rolled to obtain a positive electrode plate.

Meanwhile, the negative plate is produced in the following way. A carbon material for a negative electrode is mixed with a fluoropolymer-based bonding agent at a predetermined ratio. The resulting negative-electrode mixture is applied onto both surfaces of the copper foil (i.e. a core of the negative electrode), and is dried. After being dried, the copper foil to which the negative-electrode mixture has been applied is rolled to obtain a negative electrode plate.

A polymer electrolyte is prepared in the following manner. Ethylene carbonate (EC) and diethyl carbonate (DEC) are mixed at a volume ratio of 30:70, and 1.0 mol/L of lithium hexafluorophosphate (LiPF₆) is dissolved therein, to obtain a nonaqueous electrolytic solution.

Following this, the nonaqueous electrolytic solution is mixed with a polymer, in a weight ratio of 15:1 (solution:polymer), where the polymer is either a polypropylene glycol diacrylate (Chemical formula 1) or a polypropylene glycol dimethacrylate (Chemical formula 2). Then, 1 wt % of vinylene carbonate is mixed therewith, and 5000 ppm of t-butylperoxypyvalate is added as a polymerization starting agent, thereby obtaining a polymer electrolyte precursor.

<Chemical Formula 1>
CH₂═CHCO—O—(CH(CH₃)CH₂—O)—COCH═CH₂

<Chemical Formula 2>
CH₂═C(CH₃)CO—O—(CH(CH₃)—CH₂—O)n-COC(CH₃)═CH₂

(where n is an integer of 3 or above)

Note that as a polymer electrolyte, LiBF₄, LiN(SO₂CF₃)₂, LiN(SO₂C₂F₅)₂, or any combination of them may also be used instead of LiPF₆.

Next, the positive electrode plate and the negative electrode plate, produced as in the above manner, are respectively provided with a corresponding tab. During the process, to each tab and its vicinity (in the area of the plates), protection tape made of a cast polypropylene (CPP) (one example of cast polyolefin) is attached.

Then, the positive electrode plate and the negative electrode plate are wound spirally with a separator sandwiched therebetween, then are flattened, to form an electrode body. Here the separator is made of a polyethylene microporous membrane.

Thus formed electrode body is stored in the laminate casing that has been processed in an envelope form in advance, and the polymer electrolyte precursor is injected into the laminate casing.

The top sealing part of the laminate casing, from which the tabs protrude, is subjected to thermo-compression bonding, to seal the laminate casing, and then the sealed laminate casing is placed in an oven where the temperature is 60 degrees centigrade for 3 hours, so as to harden the polymer.

After this process, gas is purged from inside, charge is put, and final sealing is performed, to complete a battery of the embodiment example.

A comparison example battery is produced in the same way as in the embodiment example battery, except that the protection tape is formed using conventional orientated polypropylene (OPP).

<Measurement Test>

A test was conducted to check occurrence of short for the embodiment example batteries and the comparison example batteries. In the test, the embodiment example batteries and the comparison example batteries were respectively placed in a heating bath in which the temperature is increased from room temperature to 180 degrees centigrade. During this temperature change, occurrence of short was checked for both types of batteries.

As a result, there was no occurrence of short in the embodiment example batteries, whereas the comparison example batteries have caused short at the temperature of 169 degrees centigrade.

From this result, it is confirmed that, in the embodiment example batteries, the protection tape is prevented from heat shrink under a comparatively severe high heat condition as in the test, so that stable battery performance can be expected. Such a performance is considered especially advantageous for a laminated battery, because even after thermo-compression bonding process, the favorable sealing effect is maintained.

<Other Notes>

Needless to say, an entire structure of a laminated battery, excluding the protection tape of the present invention, should not be limited to those stated in the embodiment, or in the embodiment example. For example, materials of the active material for the positive electrode plate are not confined to those listed in the embodiment example, and may alternatively be lithium cobalt oxide, or lithium manganese oxide. In addition, the electrolytic solution may be in liquid form instead of gel form.

In the above-described battery, the laminate casing has a three-layer structure made of polypropylene/aluminum/nylon. In this case, if the CPP tape according to the present invention is used for the tab resins, it is desirable to use cast polypropylene as a material for the CPP tape, because if the similar material as the laminate casing is used, thermo-compression bonding will be favorably pursued.

From the same reason, when the film layer positioned in the innermost surface of the laminate casing is made of other types of polyolefin than polypropylene (e.g. polyethylene), if a cast film made of polyethylene having the similar composition is used as a material for the CPP tape, it is expected to realize effective thermo-compression bonding.

The battery according to the present invention is also usable for various types of batteries equipped with a metal laminate casing, and is not limited to laminated batteries (e.g. lithium polymer battery used as a power source of small electronic devices).

Although the present invention has been fully described by way of examples with references to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A battery comprising:
a casing;
an electrode body in which a positive electrode plate and a negative electrode plate are stacked with a separator sandwiched therebetween; and
tabs respectively connected to the positive electrode plate and the negative electrode plate, the casing being hermetically sealed with the electrode body stored therein and with part of each of the tabs exposed outside the casing, wherein
inside the casing, a cast polyolefin is attached to at least one of the following positions: i) inside the electrode body, ii) on the electrode body, and iii) on the tabs.

2. A battery according to claim 1, being a laminated battery whose casing is made of a laminate material, the battery further comprising:
protection tape attached to the positive electrode plate and the negative electrode plate, in areas corresponding to where the tabs are connected; and
tab resins respectively provided to cover parts of the tabs that positionally correspond to the sealed circumference of the casing, wherein
the casing is hermetically sealed at a circumference thereof, and
at least one of the protection tape and the tab resins is made of the cast polyolefin.

3. A battery according to claim 2, wherein
the protection tape is made of the cast polyolefin, and
the protection tape is provided with an adhesive on one side thereof that faces the positive electrode plate or faces the negative electrode plate, avoiding the vicinity of the sealed circumference of the casing.

4. A battery according to claim 1, wherein
the electrode body is a winding body in which the positive electrode plate and the negative electrode plate, both having a band shape, are wound with the separator sandwiched therebetween and are secured using securing tape made of the cast polyolefin.

5. A battery according to claim 4, wherein
the securing tape is provided with an adhesive on one side thereof that faces the positive electrode plate or faces the negative electrode plate, avoiding the vicinity of the sealed circumference of the casing.

6. A battery according to claim 2, wherein
the tab resins are made of the cast polyolefin, and
the cast polyolefin is the same, in composition, as a surface of the laminate casing that faces the tab resins.

7. A battery according to claim 2, wherein
the laminated battery is a lithium polymer battery.
